(19) United States
(12) Patent Application Publication
(10) Pub. No.: US 2022/0138994 A1
(43) Pub. Date: May 5, 2022

(54) DISPLAYING AUGMENTED REALITY RESPONSIVE TO AN AUGMENTED REALITY IMAGE

(71) Applicant: Micron Technology, Inc., Boise, ID (US)

(72) Inventors: Radhika Viswanathan, Boise, ID (US); Zahra Hosseinimakarem, Boise, ID (US); Carla L. Christensen, Boise, ID (US); Bhumika Chhabra, Boise, ID (US)

(21) Appl. No.: 17/088,793

(22) Filed: Nov. 4, 2020

(51) Int. Cl. G06T 11/00; H04L 29/06

(52) U.S. Cl. CPC G06T 11/00; G06T 2200/24; H04L 67/38

(57) ABSTRACT

Methods, devices, and systems related to a computing device for displaying an AR responsive to an AR image are described. In an example, a method can include receiving first signaling including data representing an image at an AR platform of a computing device from a camera, comparing the data representing the image to data representing a number of AR images included on the AR platform, determining that the image is an AR image of the number of AR images in response to a particular portion of the data representing the image matching data representing the AR image, receiving at a user interface of the computing device second signaling including data representing an AR associated with the AR image in response to determining the image is the AR image, and displaying the data representing the AR on the user interface in response to receiving the second signaling.

### TECHNICAL FIELD

The present disclosure relates generally to a computing device, and more particularly, to methods, apparatuses, and systems related to augmented reality (AR).

### BACKGROUND

A computing device can be, for example, a personal laptop computer, a desktop computer, a smart phone, a tablet, a wrist-worn device, a digital camera, and/or redundant combinations thereof, among other types of computing devices. In some examples, a computing device can display an augmented reality (AR) and/or perform artificial intelligence (AI) operations.

AR can overlay virtual objects on a real-world (e.g., natural) environment. For example, AR can add a 3D hologram to reality. In some examples, AR can be an interactive experience of a real-world environment where real-world objects are enhanced by computer-generated perceptual information. The AR can mask a portion of the real-world environment and/or add to the real-world environment such that it is perceived as an immersive aspect of the real-world environment. Accordingly, AR can alter a person's perception of a real-world environment. A head-up display, a headset, a smart glass, smart contacts, a light field display, a laser, and/or several sources of light can be used to create AR.

In some examples, a computing device can include an AI accelerator. An AI accelerator can include components configured to enable the computing device to perform AI operations. In some examples, AI operations may include machine learning or neural network operations, which may include training operations or inference operations, or both.

### BRIEF DESCRIPTION OF THE DRAWINGS

FIG. 1 illustrates an example of a user interface of a computing device for displaying an AR in accordance with a number of embodiments of the present disclosure.

FIG. 2 illustrates an example of a user interface of a computing device for displaying an AR in accordance with a number of embodiments of the present disclosure.

FIG. 3 illustrates an example of a user interface of a computing device for displaying an AR in accordance with a number of embodiments of the present disclosure.

FIG. 4 illustrates an example of a computing device used for displaying an AR in accordance with a number of embodiments of the present disclosure.

FIG. 5 illustrates an example of a computing device used for displaying an AR in accordance with a number of embodiments of the present disclosure.

FIG. 6 is a flow diagram of a method for displaying an AR responsive to an AR image in accordance with a number of embodiments of the present disclosure.

### DETAILED DESCRIPTION

The present disclosure includes methods, apparatuses, and systems related to displaying an AR responsive to an AR image. An example method includes receiving first signaling including data representing an image at an AR platform of a computing device from a camera of the computing device, comparing at the AR platform the data representing the image to data representing a number of AR images included on the AR platform, determining at the AR platform that the image is an AR image of the number of AR images in response to a particular portion of the data representing the image matching data representing the AR image, receiving at a user interface of the computing device second signaling including data representing an AR associated with the AR image from the AR platform in response to determining the image is the AR image, and displaying the data representing the AR associated with the AR image on the user interface of the computing device in response to receiving the second signaling.

An AR image can be an image that triggers an AR. For example, the AR can be launched on the computing device in response to the AR image being detected. The computing device can include a platform for AR, which includes a number of AR images and AR data to display an AR associated with each of the number of AR images. The AR image can be a barcode, a quick response (QR) code, or any image.

The computing device can include one or more cameras. One of the one or more cameras can be solely for detecting AR images. In a number of embodiments, one or more optical sensors can be used with one or more cameras to detect an AR image or, in contrast, one or more optical sensors can be used instead of one or more cameras to detect an AR image.

The computing device can include hardware and/or software/firmware to perform AR. The software/firmware can be included in the AR platform on an operating system of the computing device and/or included in the AR platform on an application downloaded onto the computing device. AR data from the AR platform and/or AR data stored in memory on and/or external to the computing device can be used to perform the AR via the operating system of the computing device or an application installed on the computing device.

In some examples, the AR can be displayed on the user interface of the computing device without a user opening the computing device and/or without a user opening an application on the computing device. For example, the AR can be displayed without the computing device receiving a command from a user. In a number of embodiments, the computing device can be a mobile device of a user. The user can be walking around a zoo with their mobile device. The zoo can include one or more AR images associated with different exhibits. Without downloading a zoo application to the mobile device, the mobile device can detect an AR image and display the AR. This can eliminate the need for a user to download additional applications to view particular ARs.

In a number of embodiments, one or more operations can be performed by the computing device prior to displaying the AR on the user interface. For example, the computing device can determine one or more user preferences, determine a creator of the AR, determine a genre of the AR, determine content of the AR, determine a rating of an AR, notify the user that AR is available, receive an input, and/or identify a user prior to displaying the AR.

An AR creator, as used herein, can be a person, organization, brand and/or company that creates, distributes and/or owns the AR. An AR genre can be based on the purpose of the AR. For example, AR genres can include what categories the AR is in, for example, AR genres can include advertisement, entertainment, and/or education. AR content can include the people, goods, services, and/or activities being displayed in the AR. The AR rating can include review data of the AR, popularity data of the AR, and/or age data (e.g., appropriate ages for viewing the content of the AR). The ratings can be generated by a user, other viewers, and/or other organizations. The AR creator, genre, content, and rating can be determined based on AR data associated with the AR image. The AR data associated with the AR can be included on the AR platform and/or stored in the memory of the computing device.

The computing device can receive a selection of one or more user preferences on the user interface and/or determine one or more user preferences by performing AI operations. The one or more user preferences can be stored on a memory device on and/or external to the computing device in response to receiving the one or more user preferences and/or in response to the computing device determining the one or more user preferences. For example, the one or more user preferences can include displaying an AR on the user interface responsive to determining the creator, genre, content, and/or rating of the AR. In a number of embodiments, the computing device can compare characteristics of the AR, for example, the creator, genre, content, and/or rating of the AR with the one or more user preferences and display or not display the AR in response to the comparison.

AI operations using an AI model can also be performed to determine whether or not to notify a user of the availability of an AR and/or whether or not to display an AR. User data including one or more user preferences and/or AR data can be used as weights in the AI operation. In some examples, the user data can include one or more of a user's previous responses to AR.

In a number of embodiments, a user can be notified that AR is available prior to displaying the AR. A computing device can notify a user that AR is available by producing a visual, audio, and/or vibration responsive to detecting an AR image. For example, a notification can be displayed on the user interface to notify the user that AR is available.

The computing device can display a notification on a user interface responsive to the computing device performing one or more operations to determine information about an AR. For example, the computing device can determine a creator, genre, content, and/or rating of an AR based on AR data associated with the AR image. Prior to providing a notification to a user, the computing device can compare the one or more user preferences with the AR data to determine whether the AR would be appropriate and/or of interest to the user.

As used herein, “a number of” something can refer to one or more of such things. For example, a number of computing devices can refer to one or more computing devices. A “plurality” of something intends two or more.

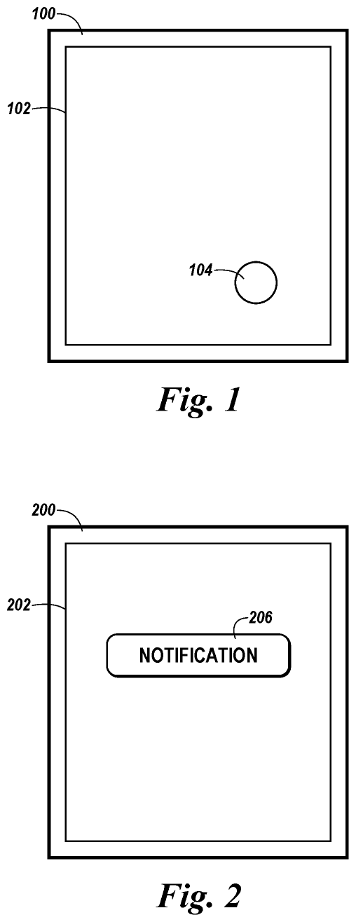

The figures herein follow a numbering convention in which the first digit or digits correspond to the drawing figure number and the remaining digits identify an element or component in the drawing. Similar elements or components between different figures may be identified by the use of similar digits. For example, reference numeral 102 may reference element “2” in FIG. 1, and a similar element may be referenced as 202 in FIG. 2. As will be appreciated, elements shown in the various embodiments herein can be added, exchanged, and/or eliminated so as to provide a number of additional embodiments of the present disclosure. In addition, the proportion and the relative scale of the elements provided in the figures are intended to illustrate various embodiments of the present disclosure and are not to be used in a limiting sense.

FIG. 1 illustrates an example of a user interface 102 of a computing device 100 for displaying an AR in accordance with a number of embodiments of the present disclosure. The user interface 102, as illustrated in FIG. 1, can further include an AR image 104. An AR image 104 can be an image that triggers an AR.

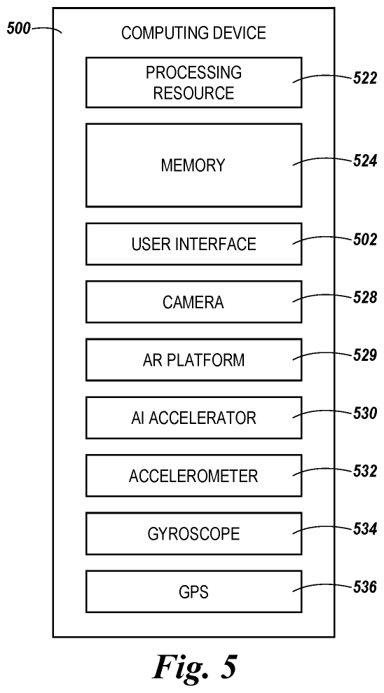

In a number of embodiments, a camera (e.g., camera 428 in FIG. 4, camera 528 in FIG. 5) can detect an AR image 104. In some examples, computing device 100 can include one or more cameras. One of the one or more cameras can be used solely for detecting AR images. In a number of embodiments, one or more optical sensors can be used with one or more cameras to detect an AR image 104 or, in contrast, one or more optical sensors can be used instead of one or more cameras to detect an AR image 104.

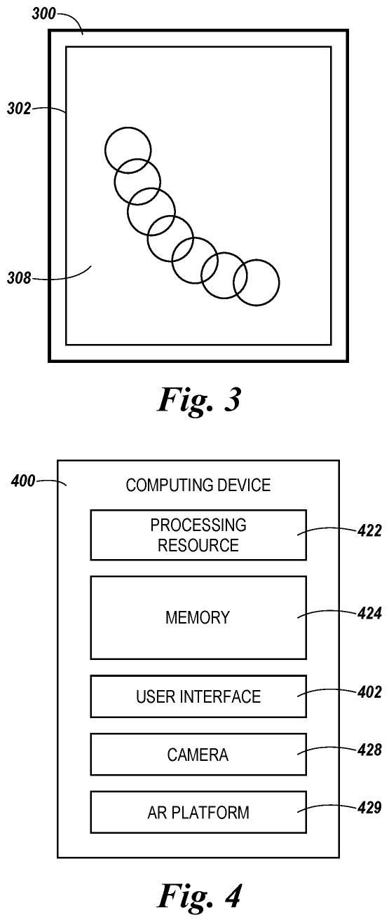

AR can overlay virtual objects on a real-world environment to mask a portion of the real-world environment and/or add to the real-world environment such that it is perceived as an immersive aspect of the real-world environment. In some examples, AR can display and/or automate a number of images and/or enhance the AR image 104 to move and/or change on the user interface 102, as shown in FIG. 3.

The user interface 102 can be generated by the computing device 100. The user interface 102 can be a graphical user interface (GUI) that can provide and/or receive information to and/or from the user of the computing device 100. The user interface 102 can be shown on a display of the computing device 100. In some examples, the display can be a touchscreen.

FIG. 2 illustrates an example of a user interface 202 of a computing device 200 for displaying an AR in accordance with a number of embodiments of the present disclosure. In a number of embodiments, the user interface 202 can be generated in response to detecting an AR image (e.g., AR image 104 in FIG. 1) via a camera. An AR image can be detected by comparing an image generated by a camera on the computing device 200 to a number of AR images included on an AR platform on the computing device 200 and determining the image generated by the camera is an AR image of the number of AR images on the AR platform. The user interface 202, as illustrated in FIG. 2, can include a notification 206. The user interface 202 can notify a user that an AR is available by displaying the notification 206. However, embodiments are not limited to displaying a notification 206 on a user interface 202. A computing device 200 can notify a user that an AR is available by producing audio and/or vibration, for example. The notification 206 can be displayed, audio can be produced, and/or vibration can be produced by the computing device 200 responsive to the computing device performing one or more operations and/or detecting an AR image.

The computing device 200 can display a notification 206 on a user interface 202 responsive to the computing device 200 determining an image generated by a camera is an AR image of a number of AR images on an AR platform included on the computing device 200 and/or in response to performing one or more operations to determine information about an AR. For example, the computing device 200 can determine a creator, genre, content, and/or rating of an AR based on AR data associated with an AR image. Prior to providing the notification 206 to a user, the computing device 200 can compare one or more user preferences with the AR data to determine whether the AR would be appropriate and/or of interest to the user.

In some examples, the user interface 202 can display the AR responsive to receiving a selection of the notification 206 on the user interface 202. A selection can be a user pressing, tapping, and/or clicking on the notification 206 displayed on the user interface 202. In a number of embodiments, the user interface 202 can display the AR responsive to the computing device 200 receiving a passcode and/or password, the computing device 200 performing facial recognition on the user, the computing device 200 performing retinal scanning on the user, and/or the computing device 200 performing fingerprint identification on the user.

A user can choose to ignore or view the AR. The notification 206 can be removed from the user interface 202 and the AR can be displayed on the user interface 202 responsive to receiving a selection to view the AR on the user interface 202. In some examples, the notification 206 can be removed from the user interface 202 responsive to the user interface 202 receiving a selection from the user to ignore (e.g., not view) the AR or a user ignoring the notification 206. For example, the notification 206 can be removed from the user interface 202 after a particular period of time has passed without the user interface 202 receiving a selection.

The notification 206 can include AR data. In some examples, the AR data can be displayed on the user interface 202 responsive to the user interface 202 receiving a selection from the user to view the AR data. The AR data can include the creator, genre, content, and/or ratings, for example. The notification 206, the AR data, and/or a portion of the AR data can be stored in memory on and/or external to the computing device 200.

A user's response to the notification 206 can be stored as user data. The user data can be stored in memory on and/or external to the computing device 200. The AR data and/or the user data can be used to perform AI operations. AI operations can, for example, set (e.g., create) one or more user preferences. The user preferences can be set based on a user's previous responses to notifications and/or a user's previous responses to AR. In some examples, the computing device 200 may not notify a user if an AR is available responsive to AR data including one or more characteristics in common with characteristics of an AR a user has previously ignored. For example, the computing device 200 may not notify a user if an AR is available responsive to the AR having a particular rating that the user has previously ignored.

FIG. 3 illustrates an example of a user interface 302 of a computing device (e.g., apparatus) 300 for displaying an AR 308 in accordance with a number of embodiments of the present disclosure. In some examples, the user interface 302 can be generated in response to detecting an AR image (e.g., AR image 104 in FIG. 1) via a camera.

In a number of embodiments, one or more operations can be performed by the computing device 300 prior to displaying the AR on the user interface 302. For example, the computing device 300 can determine one or more user preferences, determine a creator of the AR, determine a genre of the AR, determine content of the AR, determine a rating of an AR, notify the user that AR is available, receive an input, and/or identify a user prior to displaying the AR.

The computing device 300 can receive a selection of one or more user preferences on the user interface 302 and/or determine one or more user preferences by performing AI operations. AI operations using an AI model can be performed to determine whether or not to notify a user of the availability of an AR and/or whether or not to display an AR. User data including one or more user preferences and/or AR data can be used as weights in the AI operation. In some examples, the user data can include one or more of a user's previous responses to AR.

The one or more user preferences can be stored on a memory device on and/or external to the computing device 300. The one or more user preferences can include displaying an AR on the user interface 302 responsive to the creator, genre, content, or rating of the AR, for example.

FIG. 4 illustrates an example of a computing device 400 used for displaying an AR in accordance with a number of embodiments of the present disclosure. The computing device 400 can be an apparatus. As illustrated in FIG. 4, computing device 400 can include a processing resource (e.g., processor) 422, a memory 424, a user interface 402, a camera 428, and an AR platform 429. The computing device 400 can be, for example, a personal laptop computer, a desktop computer, a smart phone, a tablet, a wrist-worn device, a digital camera, and/or redundant combinations thereof, among other types of computing devices. The memory 424 can be any type of storage medium that can be accessed by the processing resource 422 to perform various examples of the present disclosure. For example, the memory 424 can be a non-transitory computer readable medium having computer readable instructions (e.g., computer program instructions) stored thereon that are executable by the processing resource 422 to receive first signaling including data representing an image at an AR platform of the computing device 400 from a camera 428 of the computing device 400, comparing at the AR platform 429 the data representing the image to data representing a number of AR images included on the AR platform 429, determine at the AR platform 429 that the image is an AR image of the number of AR images in response to a particular portion of the data representing the image matching data representing the AR image, receive at a user interface 402 of the computing device 400 second signaling including data representing an AR associated with the AR image from the AR platform 429 in response to determining the image is the AR image, and displaying the data representing the AR associated with the AR image on the user interface 402 of the computing device 400 in response to receiving the second signaling. In some embodiments, the computing device 400 can include communication devices, such as, but not limited to, radios.

The memory 424 can be volatile or nonvolatile memory. The memory 424 can also be removable (e.g., portable) memory, or non-removable (e.g., internal) memory. For example, the memory 424 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 424 is illustrated as being located within computing device 400, embodiments of the present disclosure are not so limited. For example, memory 424 can be located on an external computing resource (e.g., enabling computer readable instructions to be downloaded over the Internet or another wired or wireless connection).

The AR platform 429 can be included in an operating system (OS) of the computing device 400 and/or included in an application downloaded onto the computing device 400. A number of AR images and AR data associated with each of the number of AR images can be included on the AR platform 429. The AR platform 429 can be updated with new data periodically or in response to a user command. New AR images with their associated AR data can be added to the AR platform 429 and/or existing AR images with their associated AR data can be updated on the AR platform 429. For example, AR data associated with an existing AR image can be updated to display a new AR.

As illustrated in FIG. 4, computing device 400 includes a user interface 402. A user (e.g., operator) of computing device 400, can interact with computing device 400 via a user interface 402 shown on a display. For example, the user interface 402 via a display can provide (e.g., display and/or present) information to the user of computing device 400, and/or receive information from (e.g., input by) the user of computing device 400. For instance, in some embodiments, the user interface 402 can be a GUI that can provide and/or receive information to and/or from the user of computing device 400. The display showing the user interface 402 can be, for instance, a touchscreen (e.g., the GUI can include touchscreen capabilities).

The computing device 400 can include one or more cameras 428. The one or more cameras 428 can be used to detect an AR image. In some examples, one of the one or more cameras 428 can be used solely for detecting an AR image. In a number of embodiments, one or more optical sensors, not illustrated in FIG. 4, can be used with the one or more cameras or instead of the one or more cameras to detect an AR image.

In a number of embodiments, the computing device 400 can be a mobile device. A user of the mobile device can be shopping at a mall, for example. Various advertisements, billboards, price tags, boxes, products, etc. in the mall can include one or more AR images. When the mobile device detects an AR image on a shirt price tag, for example, the mobile device can notify the user and/or display the AR associated with the detected AR image. The AR associated with the detected AR image can be a model walking through the mall with the shirt on, for example.

In some examples, the mobile device can notify the user and/or display the AR without the user opening the mobile device and/or without the user opening an application on the mobile device. If the user does not want to be notified and/or view every AR the mobile device detects, the user can set one or more user preferences and/or the mobile device can determine one or more user preferences using AI.

For instance, the user preferences can filter when a user is notified and/or when an AR is displayed. For example, the mobile device can include one or more preferences particularly for malls. When at the mall, the mobile device may only display AR for shirts of a particular color from particular brands, for example.

FIG. 5 illustrates an example of a computing device 500 used for displaying an AR in accordance with a number of embodiments of the present disclosure. Computing device 500 can correspond to computing device 400 in FIG. 4. Computing device 500 can include a processing resource 522, a memory 524, a user interface 502, a camera 528, and an AR platform 529. The processing resource 522, the memory 524, the user interface 502, the camera 528, and the AR platform 529 can correspond to the processing resource 422, the memory 424, the user interface 402, the camera 428, and the AR platform 429, respectively in FIG. 4. As illustrated in FIG. 5, computing device 500 can further include an AI accelerator 530, an accelerometer 532, a gyroscope 534, and a global positioning system (GPS) 536.

The AI accelerator 530 can include hardware and/or software/firmware, not shown, to perform AI operations. Data stored in memory 524 on the computing device 500 and/or external to the computing device 500 can be used in performing the AI operations. The data can include user data and/or AR data. User data can include a user's response to a notification that AR is available, a user's response to an AR, and/or user preferences. AR data can include AR data associated with an AR image received from an AR platform. The AR data can include the creator, genre, content, and/or ratings of the AR, for example.

In some examples, the AI accelerator 530 can perform AI operations including machine learning or neural network operations, which may include training operations or inference operations, or both. The AR data and/or the user data can be used to perform AI operations to determine one or more user preferences, determine whether to notify a user of an AR, and/or display an AR.

Prior to providing a notification to a user and/or displaying the AR on the user interface 502, the computing device 500 can compare the one or more user preferences with the AR data to determine whether the AR would be appropriate and/or of interest to the user. The one or more user preferences can be set based on a user's previous responses to notifications and/or a user's previous responses to AR. In some examples, the computing device 500 may not notify a user and/or display an AR responsive to AR data including one or more characteristics in common with characteristics of a different AR a user has previously ignored. For example, the computing device 500 may not notify a user if an AR is available responsive to the AR including particular content that the user has previously ignored.

The accelerometer 532, the gyroscope 534, and/or the GPS 536 can be located on the computing device 500, as illustrated in FIG. 5, or external to the computing device 500. A location of the computing device 500 can be determined via the accelerometer 532, the gyroscope 534, and/or the GPS 536. In some examples, the accelerometer 532, the gyroscope 534, and/or the GPS 536 can be used when the computing device 500 is displaying an AR.

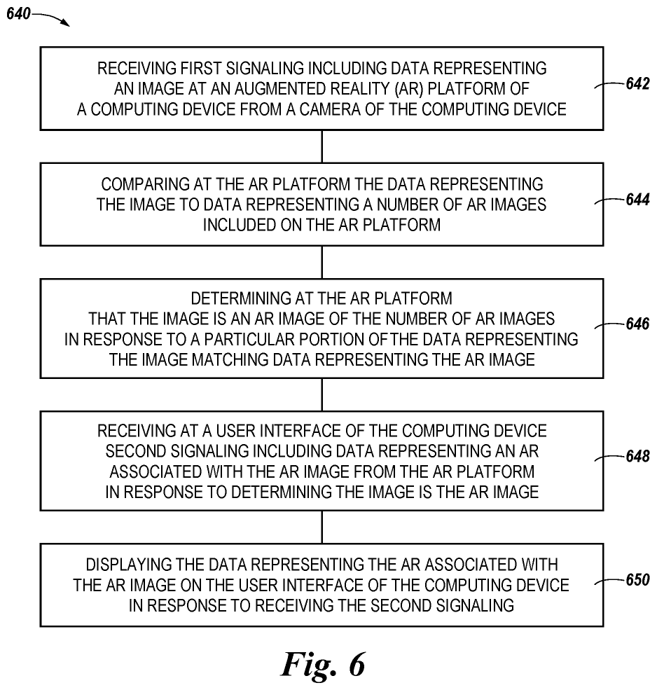

FIG. 6 is a flow diagram of a method 640 for displaying an AR responsive to an AR image in accordance with a number of embodiments of the present disclosure. At block 642, the method 640 can include receiving first signaling including data representing an image at an AR platform of a computing device from a camera of the computing device.

The AR platform can be included on an operating system of the computing device. The computing device can be, for example, a personal laptop computer, a desktop computer, a smart phone, a tablet, a wrist-worn device, a digital camera, and/or redundant combinations thereof, among other types of computing devices.

The computing device can include one or more cameras. One of the one or more cameras can be solely for detecting AR images (e.g., only used for generating data representing images to be compared with the data representing the number of AR images on the AR platform). In a number of embodiments, one or more optical sensors can be used with one or more cameras to detect an AR image or, in contrast, one or more optical sensors can be used instead of one or more cameras to detect an AR image.

At block 644, the method 640 can include comparing at the AR platform the data representing the image to data representing a number of AR images included on the AR platform. An AR image can be an image that triggers an AR.

At block 646, the method 640 can include determining at the AR platform that the image is an AR image of the number of AR images in response to a particular portion of the data representing the image matching data representing the AR image. The AR image can be associated with AR data. The AR data can be used to generate and display the AR. The AR data can be transmitted from the AR platform to the computing device responsive to the camera determining the image generated by the camera is one of the number of AR images on an AR platform.

At block 648, the method 640 can include receiving at a user interface of the computing device second signaling including data representing an AR associated with the AR image from the AR platform in response to determining the image is the AR image. The user interface can be generated by the computing device. The user interface can be a GUI that can provide and/or receive information to and/or from the user of the computing device. In some examples, the user interface can be shown on a display of the computing device.

At block 650, the method 640 can include displaying the data representing the AR associated with the AR image on the user interface of the computing device in response to receiving the second signaling. AR can overlay virtual objects on a real-world environment to mask a portion of the real-world environment and/or add to the real-world environment such that it is perceived as an immersive aspect of the real-world environment. In some examples, AR can display and/or automate a number of images and/or enhance an AR image to move and/or change on the user interface.

The computing device can include hardware and/or software/firmware to perform AR. The software/firmware can be included in the operating system of the computing device and/or included in an application downloaded onto the computing device. AR data associated with the AR image and received from the AR platform and/or AR data stored in memory on and/or external to the computing device can be used to perform the AR via the operating system of the computing device or an application installed on the computing device.

The method 640 can further include receiving third signaling including data representing a selection of one or more user preferences at the AR platform in response to the user interface receiving the selection of the one or more user preferences, receiving fourth signaling including the data representing the selection of the one or more user preferences at a memory from the AR platform in response to receiving the third signaling, storing the data representing the one or more user preferences in the memory in response to receiving the fourth signaling, comparing at the AR platform the data representing the AR to the data representing the one or more user preferences, receiving the second signaling including the data representing the AR at the user interface from the AR platform in response to comparing the data representing the AR to the data representing the one or more user preferences, and displaying the data representing the AR on the user interface in response to receiving the second signaling.

In a number of embodiments, the method 640 can include performing an AI operation at the AR platform by inputting the data representing the AR and user data as weights into an AI model. Data representing one or more user preferences can be determined based on an output of the AI operation. The user data can include one or more of a user's previous responses to AR.

A memory can receive third signaling including the data representing the one or more user preferences from the AR platform in response to determining the data representing the one or more user preferences. The data representing the one or more user preferences can be stored in the memory in response to receiving the third signaling. In some examples, the data representing the AR can be compared with the data representing the one or more user preferences and the data representing the AR can be displayed on the user interface in response to comparing the data representing the AR with the data representing the one or more user preferences.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and methods are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A method, comprising:
receiving first signaling including data representing an image at an augmented reality (AR) platform of a computing device from a camera of the computing device;
comparing at the AR platform the data representing the image to data representing a number of AR images included on the AR platform;
determining at the AR platform that the image is an AR image of the number of AR images in response to a particular portion of the data representing the image matching data representing the AR image;
receiving at a user interface of the computing device second signaling including data representing an AR associated with the AR image from the AR platform in response to determining the image is the AR image and comparing the data representing the AR to data representing one or more user preferences; and
displaying the data representing the AR associated with the AR image on the user interface of the computing device in response to receiving the second signaling.

2. The method of claim 1, further comprising receiving the first signaling at the AR platform included on an operating system of the computing device.

3. The method of claim 1, further comprising:
receiving third signaling including data representing a selection of the one or more user preferences at the AR platform in response to the user interface receiving the selection of the one or more user preferences;
receiving fourth signaling including the data representing the selection of the one or more user preferences at a memory from the AR platform in response to receiving the third signaling; and
storing the data representing the one or more user preferences in the memory in response to receiving the fourth signaling.

4. The method of claim 1, further comprising:
performing an artificial intelligence (AI) operation at the AR platform by inputting the data representing the AR and user data as weights into an AI model; and
determining the data representing the one or more user preferences based on an output of the AI operation.

5. The method of claim 4, wherein the user data includes one or more of a user's previous responses to AR.

6. The method of claim 4, further comprising:
comparing the data representing the AR with the data representing the one or more user preferences; and
displaying the data representing the AR on the user interface in response to comparing the data representing the AR with the data representing the one or more user preferences.

7. The method of claim 4, further comprising:
receiving at memory third signaling including the data representing the one or more user preferences from the AR platform in response to determining the data representing the one or more user preferences; and
storing the data representing the one or more user preferences in the memory in response to receiving the third signaling.

8. An apparatus, comprising:
a camera;
an augmented reality (AR) platform;
a user interface;
a memory; and
a processor configured to execute executable instructions stored in the memory to:
receive first signaling including data representing an image at the AR platform from the camera;
compare the data representing the image to data representing a number of AR images included on the AR platform;
determine at the AR platform that the image is an AR image of the number of AR images in response to a particular portion of the data representing the image matching data representing the AR image; and
display the data representing the AR associated with the AR image on the user interface in response to determining that the image is the AR image and in response to determining at least one of: a creator, a genre, content, or a rating of the data representing the AR.

9. The apparatus of claim 8, wherein the processor is further configured to execute the executable instructions stored in the memory to:
determine the creator of the data representing the AR.

10. The apparatus of claim 8, wherein the processor is further configured to execute the executable instructions stored in the memory to:
determine the genre of the data representing the AR.

11. The apparatus of claim 8, wherein the processor is further configured to execute the executable instructions stored in the memory to:
determine the content of the data representing the AR.

12. The apparatus of claim 8, wherein the processor is further configured to execute the executable instructions stored in the memory to:
determine the rating of the data representing the AR.

13. The apparatus of claim 8, wherein the processor is further configured to execute the executable instructions stored in the memory to generate the data representing the image at the camera, wherein the camera is only used for generating data representing images to be compared with the data representing the number of AR images on the AR platform.

14. An apparatus, comprising:
a camera;
an augmented reality (AR) platform;
a user interface;
a memory; and
a processor configured to execute executable instructions stored in the memory to:
receive first signaling including data representing an image at the AR platform from the camera;
compare the data representing the image to data representing a number of AR images included on the AR platform;
determine at the AR platform that the image is an AR image of the number of AR images in response to a particular portion of the data representing the image matching data representing the AR image;
receive at the user interface second signaling including data representing a notification that AR is available in response to determining that the image is the AR image; and
display the data representing the notification that the AR is available on the user interface in response to receiving the second signaling and in response to determining at least one of: a creator, a genre, content, or a rating of data representing the AR.

15. The apparatus of claim 14, wherein the processor is further configured to execute the executable instructions stored in the memory to:
receive at the memory third signaling including the data representing the notification that the AR is available in response to determining that the image is the AR image; and
store the data representing the notification in the memory in response to receiving the third signaling.

16. The apparatus of claim 14, wherein the processor is further configured to execute the executable instructions stored in the memory to:
receive at the processor third signaling including data representing a user response to the notification;
receive at the memory fourth signaling including the data representing the user response to the notification from the processor in response to the processor receiving the third signaling; and
store the data representing the user response to the notification in the memory in response to receiving the fourth signaling.

17. The apparatus of claim 14, wherein the processor is further configured to execute the executable instructions stored in the memory to:
determine the creator of the data representing the AR.

18. The apparatus of claim 14, wherein the processor is further configured to execute the executable instructions stored in the memory to:
determine the genre of the data representing the AR.

19. The apparatus of claim 14, wherein the processor is further configured to execute the executable instructions stored in the memory to:
determine the content of the data representing the AR.

20. The apparatus of claim 14, wherein the processor is further configured to execute the executable instructions stored in the memory to:
determine the rating of the data representing the AR.
